(19) United States
(12) Patent Application Publication
(10) Pub. No.: US 2007/0183875 A1
(43) Pub. Date: Aug. 9, 2007

(54) Ladder rack system

(76) Inventor: Paul Thibault, Sainte-Julie (CA)

Correspondence Address: Eric Fincham, 316 Knowlton Road, Lac Brome, QC, J0E 1V0, CA

(21) Appl. No.: 11/350,633

(22) Filed: Feb. 9, 2006

(51) Int. Cl. E06C 5/00; B60R 9/042; B60P 9/00

(52) U.S. Cl. 414/462; 182/127; 224/310

(57) ABSTRACT

A ladder rack device which comprises a frame mounted to a vehicle roof, the frame having at least first and second ladder retaining members and a moveable arm having a proximal and a distal end, the first ladder retaining member being mounted on the proximal end of the moveable arm, a lifting member being provided and having a first end connected at a distal end of the arm and a second end connected to the frame, the lifting member being arranged to lift the distal end of the arm and move the proximal end in an outboard direction with respect to the vehicle, the arrangement being such that the distal end of the arm can pivotably rotate and permit the arm to extend downwardly adjacent the vehicle side while a ladder retaining member thereon will be retained in a secure position. The device is relatively simple and has few moving parts.

### FIELD OF THE INVENTION

The present invention relates to a ladder rack system and more particularly, relates to a ladder rack system suited for use on the top of a vehicle.

### BACKGROUND OF THE INVENTION

Ladders are carried by many service vehicles wherein the ladders are needed for use by electricians, construction workers, etc. Typical of such vehicles are those operated by the telephone company, the gas company, cable and television companies, etc. The ladders are required for gaining access to various facilities which are typically mounted on poles or some other structure.

For many years, the ladders were carried on top of the vehicles on an ordinary roof rack as this was considered the most practical option. However, these vehicles have become higher and with the increasing weight of some ladders, it becomes extremely difficult and dangerous to reach and remove the ladders from the vehicle top.

Numerous devices have been developed and used for receiving and securely storing ladders for stationary storage and/or for transportation. These devices must address a number of considerations which are unique to storing and securing ladders. Thus, ladders are bulky, of a considerable length and relatively heavy.

Generally, there are choices as to the particular design and placement of the ladder rack storage system. Thus, with the increased height of some vehicles, it has been proposed in the art to store the ladder on the side of the vehicle. However, unless properly designed, the aesthetics and other problems lead many corporations to veto such a design. Irrespective of the placement of the rack, the rack must provide ready access to the ladder as often only one person is trying to manipulate a heavy and/or long ladder onto the ladder rack.

### SUMMARY OF THE INVENTION

It is an object of the present invention to provide a ladder rack which can be placed on the top of a vehicle and which ladder rack is both simple to use, relatively inexpensive, and aesthetically pleasing.

According to one aspect of the present invention, there is provided a ladder rack device comprising a frame designed to be mounted to a vehicle roof, the frame having mounted thereon at least first and second ladder retaining members, a moveable arm having a proximal end and a distal end, the first ladder retaining member being mounted on the proximal end of the moveable arm, a lifting member having a first end connected proximate a distal end of the arm and a second end connected to the frame, the lifting member being designed to lift the distal end of the arm and move the proximal end in an outboard direction with respect to the vehicle, the arrangement being such that the distal end of the arm can pivotably rotate and permit the arm to extend downwardly adjacent a vehicle side while a ladder mounted thereon will be retained in a secure position by the second ladder retaining member.

According to a further aspect of the present invention, there is provided an improvement in a vehicle having a ladder rack device mounted to the vehicle roof, the improvement comprising a frame secured to the vehicle roof, the frame having mounted thereon at least first and second ladder retaining members, a moveable arm having a proximal end and a distal end, the first ladder retaining member being mounted on the proximal end of the moveable arm, a lifting member having a first end connected proximate a distal end of the arm and a second end connected to the frame, the lifting member being designed to lift the distal end of the arm and move the proximal end in an outboard direction with respect to the vehicle, the arrangement being such that the distal end of the arm can pivotably rotate and permit the arm to extend downwardly adjacent a vehicle side while the ladder mounted thereon will be retained in a secure position by the ladder retaining member.

The ladder rack device of the present invention, as aforementioned, is designed to be connected to a vehicle roof and to this end, suitable attaching members known in the art may be utilized. Actually, the method of attachment may vary depending upon the particular vehicle, etc. Thus, the ladder rack device of the present invention could be mounted directly on a vehicle roof or alternatively, if the vehicle already has a roof rack arrangement, an adaptation for mounting to the existing roof rack may be utilized as is known in the art.

The ladder rack device of the present invention provides an arrangement wherein only one end of the ladder is lowered. This results in a far less complicated and less expensive system than is known in the art. At the same time, the lowering of one end is sufficient to greatly simplify the placing of and removal of the ladder from the device.

In one embodiment of the present invention, there may be provided a ladder rack device which is capable of storing two ladders, one on each side of the vehicle. In this regard, the arrangement for providing for the storage of two ladders would utilize the same frame components.

### BRIEF DESCRIPTION OF THE DRAWINGS

Having thus generally described the invention, reference will be made to the accompanying drawings illustrating an embodiment thereof, in which:

FIG. 1 is a perspective view of a ladder rack system according to the present invention when the ladder rack is in the closed position;

FIG. 2 is a view similar to FIG. 1 illustrating the storage of a ladder therein, the ladder being shown in outline;

FIG. 3 is a side view as seen from the bottom of FIG. 2;

FIG. 4 is a top plan view thereof;

FIG. 5 is an end elevational view thereof;

FIG. 6 is a top plan view illustrating the first step in the operation to lower the ladder;

FIG. 7 is an end elevational view thereof;

FIG. 8 is an illustration similar to FIG. 6 showing a further sequence in the movement of the ladder storage device;

FIG. 9 is an end elevational view of FIG. 8;

FIG. 10 is a top plan view illustrating the complete discharge of the ladder; and

FIG. 11 is an end elevational view of FIG. 10.

### DETAILED DESCRIPTION OF THE DRAWINGS

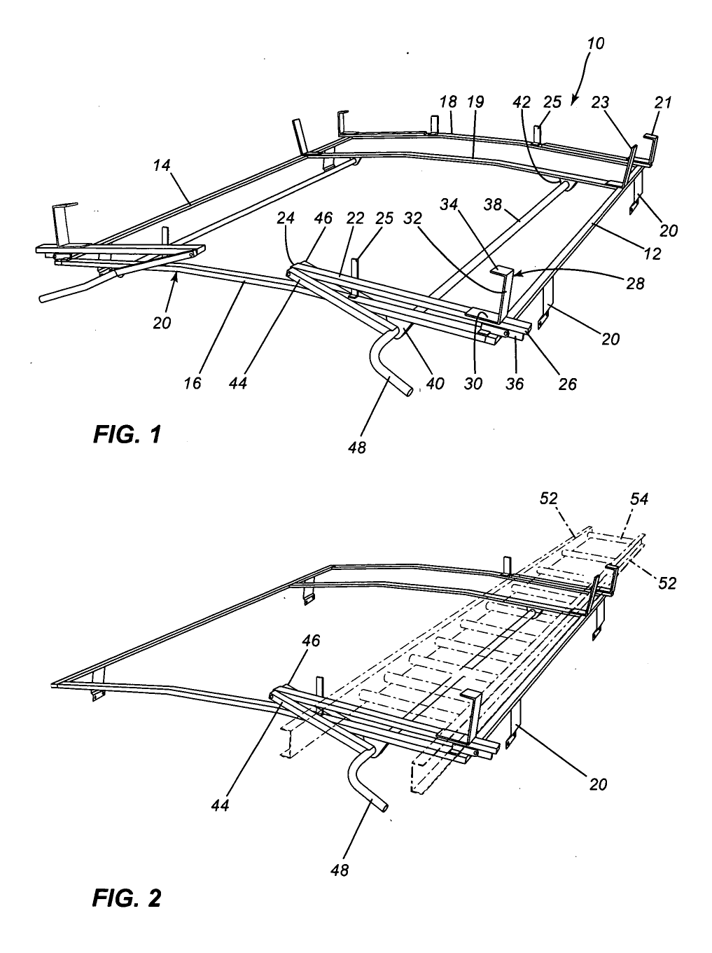

Referring to the drawings in greater detail and by reference characters thereto, there is illustrated in FIG. 1 a portion of a ladder rack system and which ladder rack system is generally designated by reference numeral 10.

Ladder rack system 10 includes a frame which is constituted by a pair of longitudinally extending frame members 12 and 14 which are designed to extend longitudinally of a vehicle body. There are also provided three transverse frame members, transverse frame members 16 and 18 being located at opposed ends of the frame and a further transverse frame member 19 located intermediately thereof.

The frame is secured to the roof of the vehicle by means of a plurality of attaching members 20 which extend downwardly from transverse frame members 16 and 18.

The ladder rack system includes a lifting arm 22, lifting arm 22 having a lifting arm distal end 24 and a lifting arm proximal end 26. Mounted at lifting arm proximal end 26 is a first ladder retaining member 28 which is of a generally U-shaped configuration and has a first leg 30 secured to lifting arm 28, a base 32, and a second leg 34. Stoppers 25 are provided on lifting arm 18 and transverse frame member 16 to maintain a ladder in a storage position.

At the other end of the device, there is provided a second ladder retaining member 21 which is also of a U-shaped configuration and which is secured to transverse frame member 18.

A third ladder retaining member 23 is mounted on transverse frame member 19. In this regard, while ladder retaining members 28 and 21 are mounted in a longitudinal line which is generally parallel to the longitudinal axis of the vehicle, ladder retaining member 23 is slightly inboard of such a longitudinal line for reasons which will become apparent hereinbelow.

Lifting arm 22 fits within a guide element 36 mounted on first transverse frame member 16 for reasons which will become apparent hereinbelow.

A rotatable rod 38 is rotatably journaled in a pair of mounting brackets 40 and 42 which are secured to the underside of transverse frame members 16 and 19 respectively.

Mounted at distal end 24 of lifting arm 22 are first and second actuators 44 and 46. Each of actuators 44, 46 is pivotably secured to the distal end of lifting arm 22 and at the other end thereof, are secured to rotatable rod 38.

At one end of rotatable rod 38, there is provided a handle generally designated by reference numeral 48 and which handle can be utilized to manually rotate rotatable rod 38.

For ease of illustration, applicant is showing a single ladder as may be utilized with the present invention. It will be understood that normally an extension ladder would be employed. The ladder generally designated by reference numeral 50 includes, in a conventional manner, parallel rails 52 with rungs 54 extending therebetween.

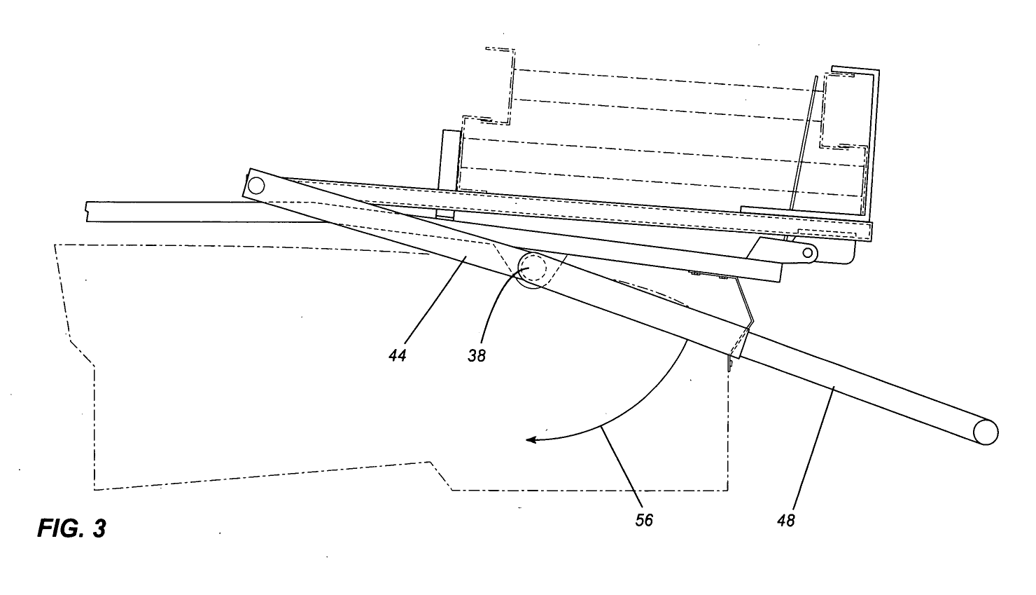

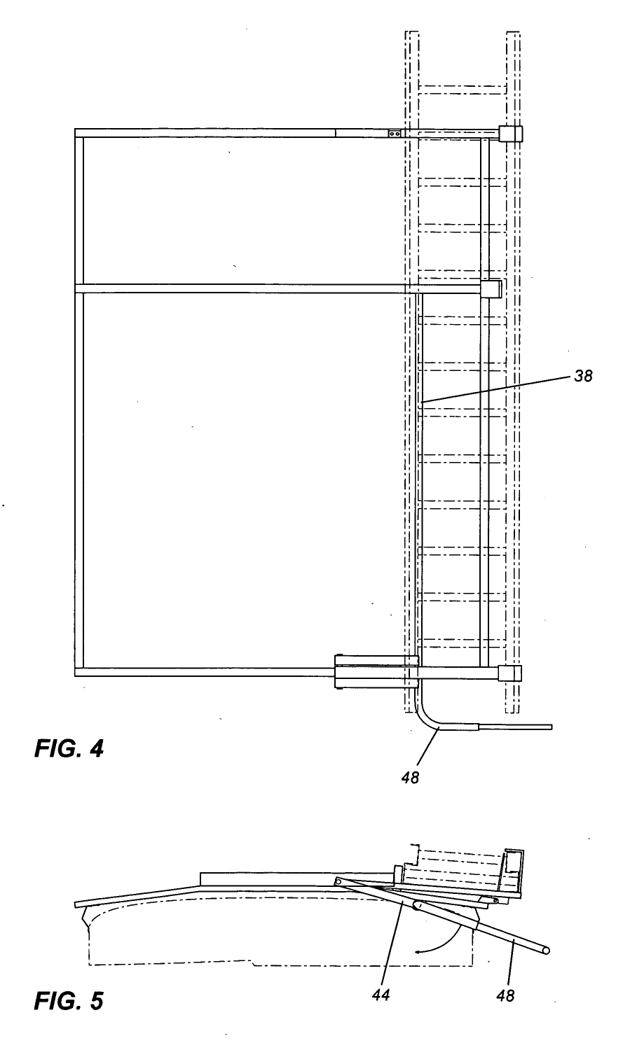

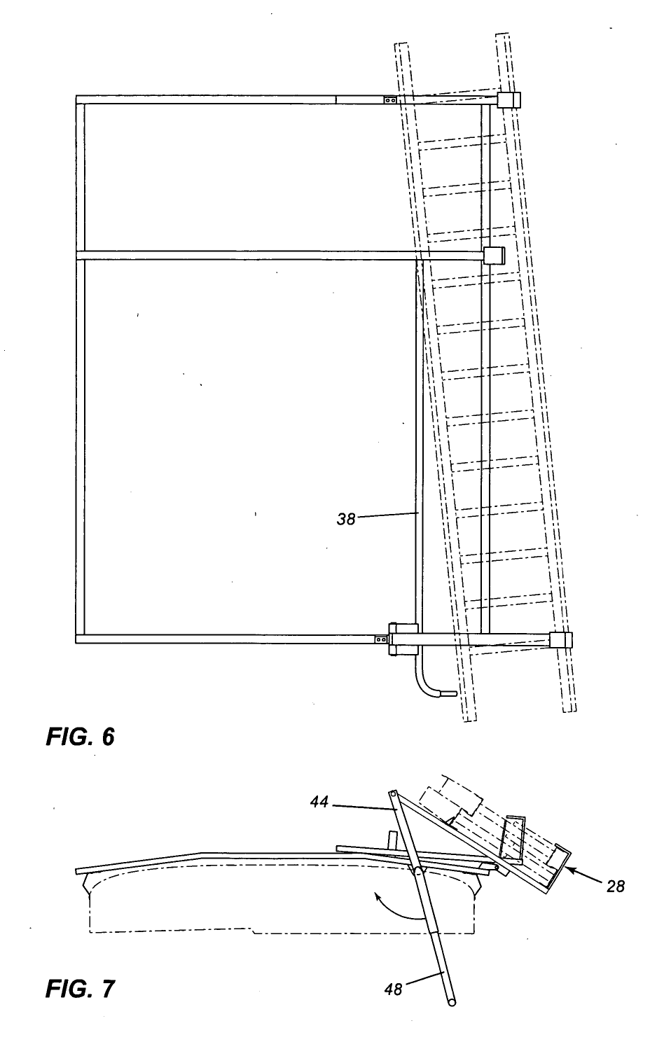

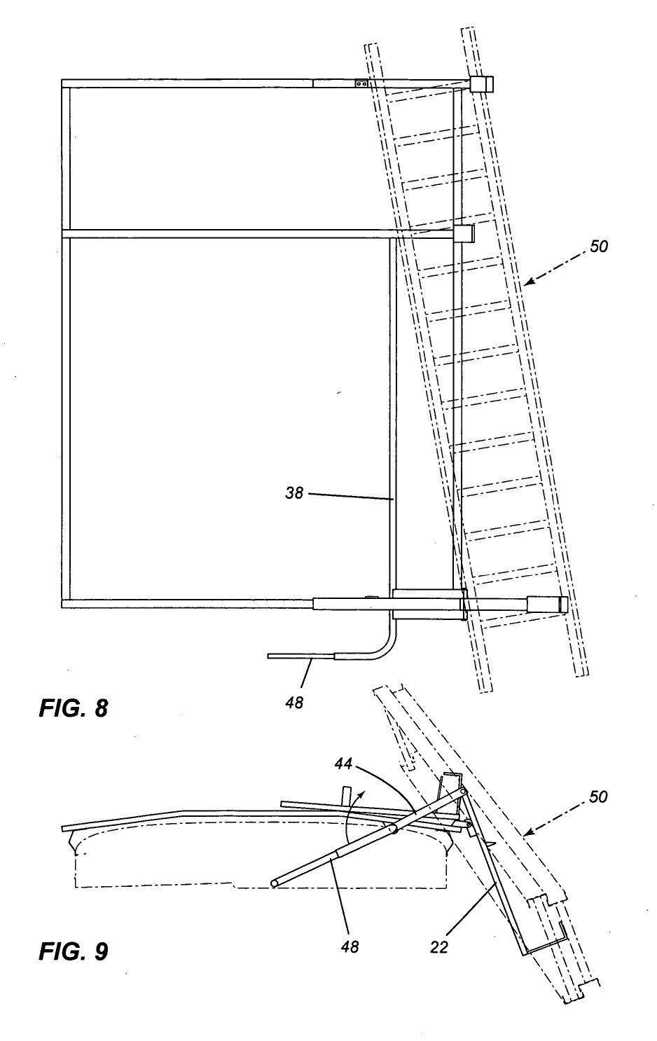

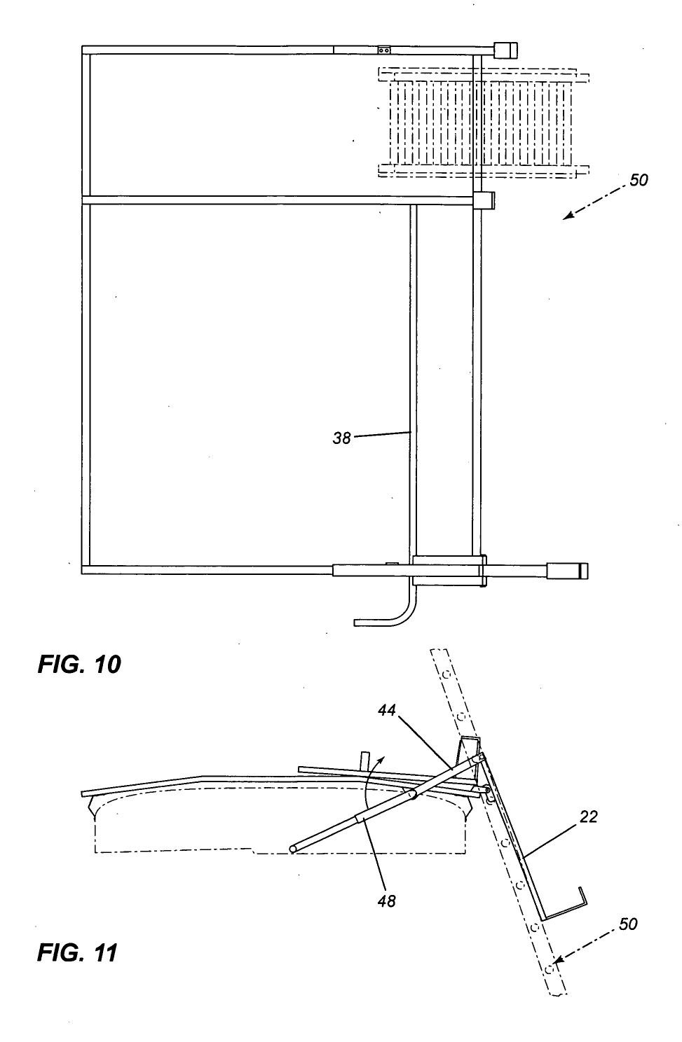

The sequence of the opening of the ladder storage device to remove the ladder therefrom is shown in FIGS. 3 through 11. In this regard, handle 48 is rotated as shown by arrow 56. This results in the pivoting of first and second actuators 44, 46 which are connected to the distal end of lifting arm 22. Lifting arm 22 is then raised and the proximal end 26 thereof will extend outboard of the vehicle and downwardly. The ladder is retained in position by third ladder retaining member 23 which will engage the inner side of rail 52 and also one of the rungs 54 to prevent movement of the ladder 50. Once one end of the ladder has been lowered, it is easy to remove from the rack by a lifting motion.

As shown in FIG. 1, on the opposite side of the vehicle, there may be provided an arrangement for retaining a second ladder. As the device would be substantially symetrical about a longitudinal line, the second ladder retaining arrangement is described herein.

It will be understood that the above described embodiments are for purposes of illustration only and that changes and modifications may be made thereto without departing from the spirit and scope of the invention.

I claim:

1. A ladder rack device comprising a frame designed to be mounted to a vehicle roof, said frame having mounted thereon at least first and second ladder retaining members, a moveable arm having a proximal end and a distal end, said first ladder retaining member being mounted on said proximal end of said moveable arm, a lifting member having a first end connected proximate a distal end of said arm and a second end connected to said frame, said lifting member being designed to lift said distal end of said arm and move said proximal end in an outboard direction with respect to said vehicle, the arrangement being such that the distal end of said arm can pivotably rotate and permit said arm to extend downwardly adjacent a vehicle side while a ladder mounted thereon will be retained in a secure position by said second ladder retaining member.

2. The ladder rack device of claim 1 wherein said first ladder retaining member is located at a first end of said frame, said second ladder retaining member being mounted at a second end of said frame, and further including a third ladder retaining member intermediate said first and second ladder retaining members.

3. The ladder rack device of claim 1 wherein both said first and said second ladder retaining members have a generally U-shaped configuration.

4. The ladder rack device of claim 1 further including a rod rotatably journaled in said frame, said lifting member being secured to said rod.

5. The ladder rack device of claim 4 further including a handle secured to said rod.

6. The ladder rack device of claim 2 wherein said frame comprises first and second longitudinally extending members substantially parallel to the vehicle longitudinal axis, and free transverse members extending between said longitudinally extending members.

7. The ladder rack device of claim 6 wherein said first, second and third ladder retaining members are each attached to a respective one of said transversely extending frame members.

8. The ladder rack device of claim 1 further including attaching means for securing said device to the vehicle roof.

9. The ladder rack device of claim 7 wherein said first and second ladder retaining members are located in a longitudinally extending line substantially parallel to the longitudinal vehicle axis and said third ladder retaining member is located inwardly of said longitudinally extending line.

10. In a vehicle having a ladder rack device mounted on a roof thereof, the improvement wherein said ladder rack device comprises a frame secured to said vehicle roof, said frame having mounted thereon at least first and second ladder retaining members, a moveable arm having a proximal end and a distal end, said first ladder retaining member being mounted on said proximal end of said moveable arm, a lifting member having a first end connected proximate a distal end of said arm and a second end connected to said frame, said lifting member being designed to lift said distal end of said arm and move said proximal end in an outboard direction with respect to said vehicle, the arrangement being such that the distal end of said arm can pivotably rotate and permit said arm to extend downwardly adjacent a vehicle side while the ladder mounted thereon will be retained in a secure position by said ladder retaining member.

11. The improvement of claim 10 wherein said first ladder retaining member is located at a first end of said frame, said second ladder retaining member being mounted at a second end of said frame, and further including a third ladder retaining member intermediate said first and second ladder retaining members.
